(19) United States
(12) Patent Application Publication
(10) Pub. No.: US 2014/0067706 A1
(43) Pub. Date: Mar. 6, 2014

(54) SYSTEM AND METHOD FOR ANALYZING AND REPORTING HEATLH PLAN MANAGEMENT PERFORMANCE

(71) Applicants: Johnathan Mun, Dublin, CA (US); Thomas Michael Schmidt, Iowa City, IA (US)

(72) Inventors: Johnathan Mun, Dublin, CA (US); Thomas Michael Schmidt, Iowa City, IA (US)

(21) Appl. No.: 14/016,666

(22) Filed: Sep. 3, 2013

Related U.S. Application Data
(60) Provisional application No. 61/696,394, filed on Sep. 4, 2012.

(51) Int. Cl. G06Q 10/10

(52) U.S. Cl. CPC G06Q 10/1057
USPC 705/322

(57) ABSTRACT

The present invention provides analytic utilities to an employer or health plan administrator as the financial underwriter of medical, prescription drug, and disability income protection for employees. It is specifically designed to integrate the use of evidence based clinical performance data and prescription drug possession ratios as part of a network optimization application; provide insights into disease progression and population migration over multiple time periods; calculate the impact on productivity as result of risk levels and health conditions; and make available advanced financial modeling capabilities utilizing econometric models and simulation.

### CROSS REFERENCE TO RELATED APPLICATIONS

This application claims the benefit of U.S. Provisional Patent Application No. 61/696,392 filed Sep. 4, 2012, the entire disclosure of which is incorporated herein by reference.

The application also claims the benefit of U.S. Non-Provisional Utility patent application Ser. No. 13/786,786, filed Mar. 6, 2013, which claims priority to U.S. Provisional Patent Application No. 61/612,941, filed Mar. 19, 2012, the entire disclosure of both is incorporated herein by reference.

### FIELD OF THE INVENTION

The present invention is applicable in the fields of health care and health plan management and was originated to provide analytic utilities to health insurance providers.

### COPYRIGHT AND TRADEMARK NOTICE

A portion of the disclosure of this patent document contains materials subject to copyright and trademark protection. The copyright and trademark owner has no objection to the facsimile reproduction by anyone of the patent document or the patent disclosure as it appears in the U.S. Patent and Trademark Office patent files or records, but otherwise reserves all copyrights whatsoever.

### BACKGROUND

Employers who wish to provide and underwrite health insurance for their employees and their dependents may find it challenging to manage a company health plan. There are many performance metrics that are constantly changing as employees come and go, and as insured members change their habits, lifestyle, and vocational duties. In addition, health care providers are constantly making treatment decisions that affect not only the patient, but the company providing insurance coverage for the patient. Keeping track of current costs and projecting future costs is critical for maintaining a viable healthcare plan and making any necessary adjustments. Intelligent, relevant information about the insured population and their treatment is also essential for preemptively identifying potential problems that can be addressed before they reach crisis proportions. There is therefore a need for a system and method for tracking and reporting critical variables that affect a company's healthcare plan and measuring, analyzing and reporting healthcare costs and cost-effecting activity in real time.

### SUMMARY OF THE INVENTION

The present invention, with its preferred embodiment encapsulated within Health Quant Data Modeler (HQDM) software is applicable for firms that have an interest in a set of highly focused, incisive analytic utilities designed to enhance the health plan management efforts of the firm that continues to provide employer-sponsored health insurance coverage. The Health Quant Premium Content (HQPC) may be accessed as an optional election for those firms that have the base license to HQDM. It provides the following five utilities: Evidence-Based Medicine, Population Migration Matrix, Benchmarking, Health Productivity Management, and Advanced Financial Analytics. These utilities may be licensed as a group or individually.

According to an embodiment of the present invention, a computer program product for providing a process of analyzing and reporting operational performance for health plan management includes: a non-transitory computer readable medium; and computer program code, encoded on the computer readable medium, including: an evidence-based medicine module, wherein said evidence-based medicine module is configured to determine the degree of healthcare provider conformity with clinical guidelines, determine patient compliance with a prescribed medication regimen, a population migration module, wherein said population migration module categorizes insured members into cost groups; a benchmarking module, wherein said benchmarking module compares an insured member or group's healthcare costs to a benchmark for a person or group having a similar demographic profile; a health productivity module, wherein said health productivity module determines the cost impact that results from a change in a member's health conditions and/or risk level; and a financial analytics module, wherein said financial analytics module provides forecasts of future costs and possible outcomes based, at least in part, on the results provided by one or more of the above modules.

According to an embodiment of the present invention, the evidence based medicine module is a third-party evidence-based medicine software application.

According to an embodiment of the present invention, the clinical guidelines comprise detailed physician measurement metrics for treating a specific disease.

According to an embodiment of the present invention, the clinical guidelines comprise one or more identified measures of care.

According to an embodiment of the present invention, the identified measures of care are from the chronic disease management guidelines published in “Technical Specifications for Physician Measurement.”

According to an embodiment of the present invention, the identified measures of care comprise subsets of the “Healthcare Effectiveness Data and Information Set” (HEDIS) measures developed by the National Committee for Quality Assurance (NCQA).

According to an embodiment of the present invention, the degree of healthcare provider conformity comprises a clinical compliance percentage.

According to an embodiment of the present invention, the patient compliance with a prescribed medication regimen is determined by a medicine possession ratio.

According to an embodiment of the present invention, the cost groups are based on costs associated with an insured member's healthcare claims over a certain period of time.

According to an embodiment of the present invention, the cost impact is based, at least in part, on number of days absent from work

According to an embodiment of the present invention, the cost impact is based, at least in part, on number of unproductive work days over a specified period of time.

According to an embodiment of the present invention, the cost impact is compared to a statistical mean.

According to an embodiment of the present invention, a system for analyzing and reporting operational performance for healthcare management includes: a processor; a memory coupled to the processor, the memory having processor executable instructions stored therein, wherein execution of said processor executable instructions performs a process for analyzing and reporting operational performance comprising: determining the degree of healthcare provider conformity with clinical guidelines; determining patient compliance with a prescribed medication regimen; categorizing insured members into cost groups; comparing an insured member or group's healthcare costs to a benchmark for a person or group having a similar demographic profile; determining the cost impact resulting from a change in a member's health conditions and/or risk level; and forecasting future costs and possible outcomes based, at least in part, on the results provided by one or more of the above steps.

According to an embodiment of the present invention, the clinical guidelines comprise detailed physician measurement metrics for treating a specific disease.

According to an embodiment of the present invention, the clinical guidelines comprise one or more identified measures of care.

According to an embodiment of the present invention, the one or more identified measures of care are from the chronic disease management guidelines published in “Technical Specifications for Physician Measurement.”

According to an embodiment of the present invention, the identified measures of care comprise subsets of the “Healthcare Effectiveness Data and Information Set” (HEDIS) measures developed by the National Committee for Quality Assurance (NCQA).

According to an embodiment of the present invention, the degree of healthcare provider conformity comprises a clinical compliance percentage.

According to an embodiment of the present invention, the patient compliance with a prescribed medication regimen is determined by a medicine possession ratio.

According to an embodiment of the present invention, the cost groups are based on costs associated with an insured member's healthcare claims over a certain period of time.

According to an embodiment of the present invention, the cost impact is based, at least in part, on number of days absent from work or number of unproductive work days over a certain period of time.

According to an embodiment of the present invention, the risk level may be divided into one or more risk categories.

According to an embodiment of the present invention, the health conditions are divided into one or more categories based on number of health conditions.

According to an embodiment of the present invention, the health conditions are divided into one or more categories based on type of health conditions.

According to an embodiment of the present invention, the cost impact is compared to a statistical mean.

According to an embodiment of the present invention, a method for analyzing and reporting operational performance for healthcare management includes the steps of: determining the degree of healthcare provider conformity with clinical guidelines; determining patient compliance with a prescribed medication regimen; categorizing insured members into cost groups; comparing an insured member or group's healthcare costs to a benchmark for a person or group having a similar demographic profile; determining the cost impact resulting from a change in a member's health conditions and/or risk level; and forecasting future costs and possible outcomes based, at least in part, on the results provided by one or more of the above steps.

The foregoing and other objects and features of the present invention will be understood and appreciated from the ensuing detailed description of the invention and the drawings that form parts of the present application.

### BRIEF DESCRIPTION OF THE DRAWINGS

FIG. 1 illustrates a schematic overview of a computing device, in accordance with an embodiment of the present invention.

FIG. 2 illustrates a network schematic of a system, in accordance with an embodiment of the present invention.

FIG. 3 is a process flow diagram detailing an exemplary method in accordance with an embodiment of the present invention.

FIG. 4 is a schematic view of a system according to an embodiment of the present invention.

### DETAILED DESCRIPTION OF THE INVENTION

The present invention is applicable in the fields of health care and health plan management and was originated to provide analytic utilities to health insurance providers.

According to an embodiment of the present invention, the computer-implemented system and methods herein described may comprise one or more separate and individually executable applications.

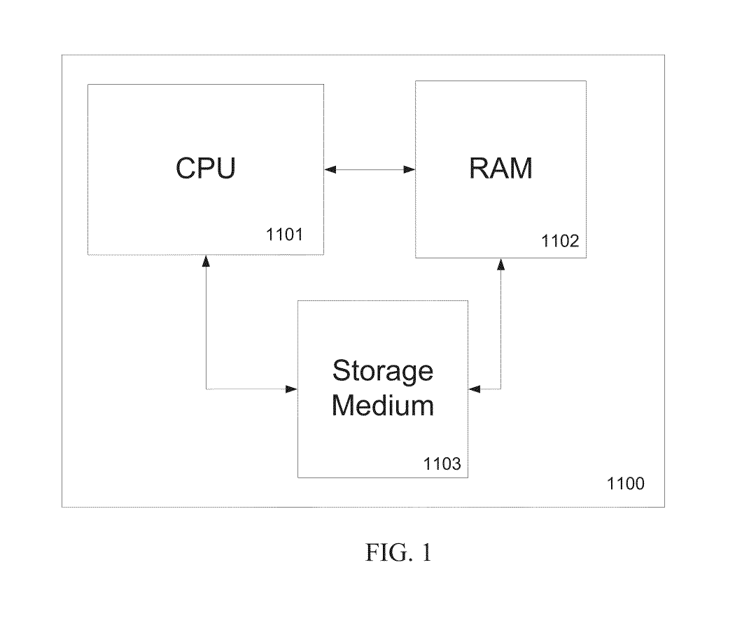

According to an embodiment of the present invention, the system and method are accomplished through the use of one or more computing devices. As shown in FIG. 1, one of ordinary skill in the art would appreciate that a computing device 1100 appropriate for use with embodiments of the present application may generally comprise one or more central processing unit (CPU) 1101, random access memory (RAM) 1102, and a storage medium (e.g., hard disk drive, solid state drive, flash memory, cloud storage) 1103. Examples of computing devices usable with embodiments of the present invention include, but are not limited to, personal computers, smart phones, laptops, mobile computing devices, tablet PCs, and servers. The term “computing device” may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system, and provided by the system to users of the system across local area networks (LANs, e.g., office networks, home networks) or wide area networks (WANs, e.g., the Internet). In accordance with the previous embodiment, the system may comprise numerous servers communicatively connected across one or more LANs and/or WANs. One of ordinary skill in the art would appreciate that there are numerous manners in which the system could be configured, and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however, a user may be able to compose data offline that will be consumed by the system when the user is later connected to a network.

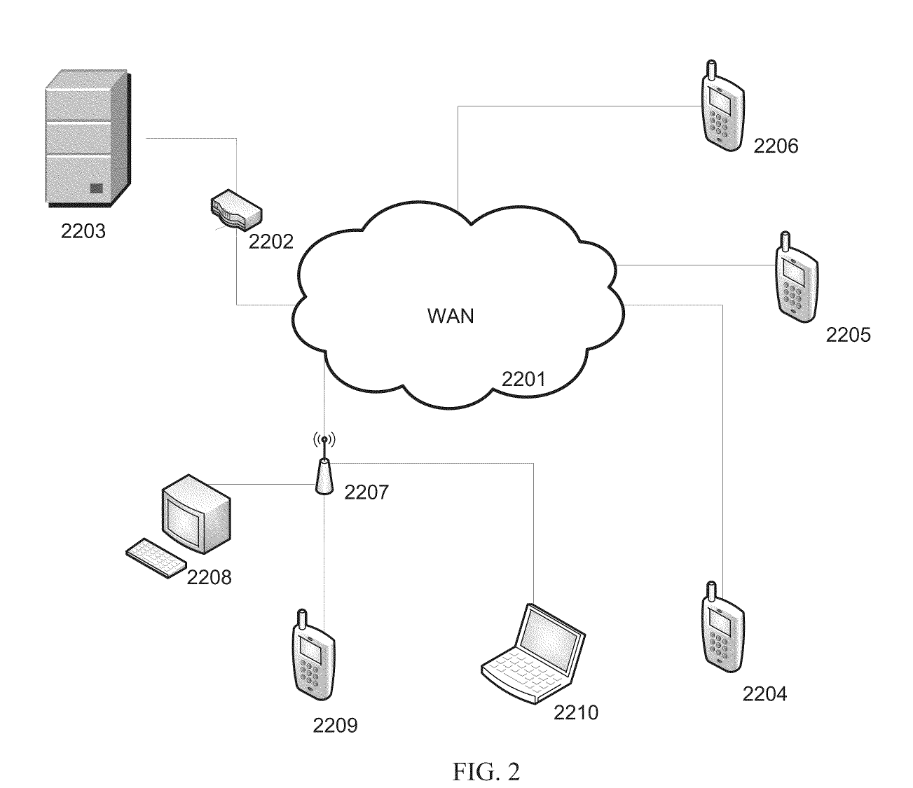

Referring to FIG. 2, a schematic overview of a system in accordance with an embodiment of the present invention is shown. The system consists of one or more application servers 2203 for electronically storing information used by the system. Applications in the application server 2203 may retrieve and manipulate information in storage devices and exchange information through a WAN 2201 (e.g., the Internet). Applications in a server 2203 may also be used to manipulate information stored remotely and to process and analyze data stored remotely across a WAN 2201 (e.g., the Internet).

According to an exemplary embodiment, as shown in FIG. 2, exchange of information through the WAN 2201 or other network may occur through one or more high-speed connections. In some cases, high-speed connections may be over-the-air (OTA), passed through networked systems, directly connected to one or more WANs 2201, or directed through one or more routers 2202. Router(s) 2202 are completely optional, and other embodiments in accordance with the present invention may or may not utilize one or more routers 2202. One of ordinary skill in the art would appreciate that there are numerous ways a server 2203 may connect to WAN 2201 for the exchange of information, and embodiments of the present invention are contemplated for use with any method for connecting to networks for the purpose of exchanging information. Further, while this application refers to high-speed connections, embodiments of the present invention may be utilized with connections of any speed.

Components of the system may connect to a server 2203 via WAN 2201 or other network in numerous ways. For instance, a component may connect to the system (i) through a computing device 2212 directly connected to the WAN 2201; (ii) through a computing device 2205, 2206 connected to the WAN 2201 through a routing device 2204; (iii) through a computing device 2208, 2209, 2210 connected to a wireless access point 2207; or (iv) through a computing device 2211 via a wireless connection (e.g., CDMA, GMS, 3G, 4G) to the WAN 2201. One of ordinary skill in the art would appreciate that there are numerous ways that a component may connect to a server 2203 via WAN 2201 or other network, and embodiments of the present invention are contemplated for use with any method for connecting to a server 2203 via WAN 2201 or other network. Furthermore, a server 2203 could be a personal computing device, such as a smartphone, acting as a host for other computing devices to connect to.

According to an embodiment of the present invention, HQPC allows for individual application of utilities, including, but not limited to, an Evidence-Based Medicine application, a Population Migration Matrix application, a Health Productivity Management application, and an Advanced Financial Analytics application.

### Evidence-Based Medicine

According to an embodiment of the present invention, Evidence-Based Medicine is an application that identifies the clinical gaps in care using physician measurement metrics and calculates prescription drug adherence using medicine possession ratios within specific disease categories. In a preferred embodiment, Evidence-Based Medicine is the measurement of physician compliance with clinical guidelines deemed to be the standard practice guidelines for diseases and of patient compliance with prescribed medication regimen.

According to an embodiment of the present invention, the issues measured by Evidence-Based Medicine include, but are not limited to, nonconformity to verified medical treatments that often lead to less than desirable outcomes including unnecessary hospitalization, overutilization of clinical services, complications in the condition, disease state progression, premature disability or death, and lack of patient adherence to a prescribed medication regimen. In a preferred embodiment, this utility is designed to use detailed physician measurement metrics within specific disease states in order to provide useful data in a decision support role toward network optimization.

According to an embodiment of the present invention, the utility may be developed on two tracks. In a first preferred embodiment, the track is a custom build approach where the client election is to use a proprietary application or an externally licensed third-party evidence-based medicine software application as a licensee. The custom build approach means the utility gains access through an application programming interface (API) and then map, implement, and operationalize. In a second preferred embodiment, the track is a default setup and is designed to use a specific subset of identified measures of care from among the chronic disease management guidelines as published in the Technical Specifications for Physician Measurement that outline the specific Healthcare Effectiveness Data and Information Set (HEDIS) measures developed by the National Committee for Quality Assurance (NCQA). In a preferred embodiment of the second embodiment, the measures of care are licensed from the NCQA and contain the mapping logic that matches the proper medical billing codes (i.e., Current Procedural Terminology [CPT], Healthcare Common Procedure Coding System [HCPCS], International Classification of Diseases [ICD], Uniform Billing Codes for Provider Service [UB], Diagnosis Related Groups [DRG], and Logical Observation Identifiers Names and Codes [LOINC]) and National Drug Codes (NDC) for the specific measures in order to capture the necessary information to produce the output. These clinical measures are updated by the NCQA annually, and the NDC listing is updated by the Food and Drug Administration (FDA) monthly. In a preferred embodiment, specific codes may be added or deleted as warranted from time to time. The specific subsets of HEDIS chronic condition guideline measures that may be used include, but are not limited to, (PBH) Persistence of Beta-Blocker Treatment After a Heart Attack, (CDC) Comprehensive Diabetes Care, (CBP) Controlling High Blood Pressure, (CMC) Cholesterol Management for Patients With Cardiovascular Conditions, (ASM) Use of Appropriate Medications for People With Asthma, (SPR) Use of Spirometry Testing in the Assessment and Diagnosis of COPD, (PCE) Pharmacotherapy Management of COPD Exacerbation, and (MPM) Annual Monitoring for Patients on Persistent Medications

According to an embodiment of the present invention, the three main sources for data inputs are the eligibility maintenance, medical claims transactional processing, and pharmacy benefit management claims systems.

According to an embodiment of the present invention, the process is based upon the development of cohorts using SQL queries. In a preferred embodiment, the data tables are chosen from among a drop-down list, variables are selected from within the chosen table, and condition expressions are written mapping variables into specific cohorts. In another preferred embodiment, external data tables may be incorporated into the cohort process, for example, the introduction of risk scores and other predictive analytics measures tagged to a member. These external files may be a client-specific proprietary application or may be externally licensed from a third party as a licensee.

According to an embodiment of the present invention, a custom table is created to integrate the desired cohorts, a computation generates the tabular results, and graphics are generated in two- and three-dimensional line graphs or two- and three-dimensional bar graphs with X-axis data descriptions and Y-axis values.

According to an embodiment of the present invention, the two main outputs are clinical compliance percentages and prescription drug adherence percentages measured by medicine possession ratios.

According to an embodiment of the present invention, the clinical compliance percentages are reported by the specific HEDIS chronic condition guideline measure as an aggregate compliance percentage for all of the measures and as an aggregate calculation for each measure. In a preferred embodiment, a detailed expanded table is generated for each measure that includes, but is not limited to, each provider, their de-identified members (patients), the total number of compliance measures, the total number of measures completed, the percentage of measures completed, the total number of measures not completed, and the percentage of measures not completed.

According to an embodiment of the present invention, the prescription drug adherence percentages are reported by the specific HEDIS chronic condition guideline measure in aggregate for all of the measures and as an aggregate calculation for each measure. In a preferred embodiment, a detailed expanded table is generated for each measure that includes, but is not limited to, each de-identified member, the specific NDC drug listing, and the medicine possession ratio for each NDC code.

According to an embodiment of the present invention, the medicine possession ratio is calculated by setting the begin date and the end date for the measurement period. In a preferred embodiment, the medicine possession ratio is calculated as follows: 1) The begin date is the date of the first prescription fill and the end date is the date of last prescription fill date. 2) The total days supplied calculation is performed, which sums the number of days supplied from the first prescription fill date (begin date) to the last prescription fill date (end date). 3) The total days elapsed calculation is the total number of days from the first prescription fill date (begin date) to the last prescription fill date (end date) excluding the number of inpatient hospital days during this period. 4) The total days supplied count is divided by the total days elapsed count to determine the medicine possession ratio percentage. An illustrative example is the medicine possession ratio of 60% (90±150) calculated as the total days supplied (90) divided by the total days elapsed (160) less the number of inpatient hospital days (10). In the event the pharmacy benefit manager (PBM) has calculated the medicine possession ratios, the application would import, tag to the member, and map to the specific HEDIS chronic condition guideline measure.

According to an embodiment of the present invention, all dashboard capabilities are available for both tracks under Evidence-Based Medicine. In a preferred embodiment results may be saved, retrieved, and populated within the global dashboard.

### Population Migration Matrix

According to an embodiment of the present invention, the Population Migration Matrix is an application that uses a transitional risk matrix to map the migration of members within specific clinical categories, over defined periods of time, and calculates their per member per month costs for both periods for use as a disease management measurement tool.

According to an embodiment of the present invention, the Population Migration Matrix maps total membership (employees and dependents) into cost groups. In a preferred embodiment, this transitional risk matrix illustrates the migration of individuals within a population across the defined cost categories over multiple time periods. In an alternative preferred embodiment, this matrix can be constructed for the total population or for specific cohorts as defined in the evidence-based medicine section. It is a customized stratification based upon dollar control limits set by the user. For example, the client may want to see the migration across four broad-based cost categories such as Low Claims ($0 to $500 in claims cost per year), Moderate Claims ($501 to $5,000 in claims cost per year), High Claims ($5,001 to $50,000), and Catastrophic Claims ($50,001+). The control limits that are used to create these four bands would be $500, $5,000, and $50,000, respectively. In a preferred embodiment, the user can set any number of bands with the default set to four and a user override requirement set at ten (if there are more than ten, they will be prompted to either recalibrate their existing bands or override to create more than ten).

According to an embodiment of the present invention, the user defines the measurement time periods, the categories, and the upper control limit for each band. In a preferred embodiment, the layers are the same for both the X-axis and the Y-axis. The Y-axis represents the baseline period for measurement and the X-axis represents the migration period. The measurement periods are calculations and default to twelve-month periods. The measurement periods are the exact same time periods for both axes (by default), but a different time period may be selected for either axis if desired.

According to an embodiment of the present invention, the main output is a matrix that shows the count and the cost. In a preferred embodiment, the count is the number of individuals in each category where the count is based upon employees or members (employees plus dependents) as selected by the user. In the preferred embodiment, the cost (restricted to the count selection method) may be per employee per year (PEPY), per employee per month (PEPM), per member per year (PMPY), or per member per month (PMPM), at the user selection, is calculated as a cost in each category, and shows these dollar amounts for each time period.

According to an embodiment of the present invention, the total aggregate dollars are accounted for in each category and the total dollars are accounted for in both periods. In a preferred embodiment, only individuals covered during both periods are reported in the matrix. Individuals no longer employed or newly employed and not covered in both measurement periods are footnoted with the total number of individuals and their cost included in the aggregate for reconciliation.

According to an embodiment of the present invention, all dashboard capabilities are available for Population Migration Matrix. In a preferred embodiment, results may be saved, retrieved, and populated within the global dashboard.

### Benchmarking

According to an embodiment of the present invention, Benchmarking is an application that compares the current per employee per year health-care cost to private and public measures.

According to an embodiment of the present invention, Benchmarking is the process of comparing the idiosyncratic health-care costs for a specific population over a definite measurement period against those measures deemed to be both statistically credible and representative of the systemic health-care costs that most closely describe the population to be measured in terms of demographics, firmographics, plan design, and geography. In a preferred embodiment, the application is designed to map a firm's eligibility and cost data that most closely match the relevant factors from the external data sources. The external data sources include, but are not limited to, all commercial third-party private data benchmarking sources (e.g., Milliman, Mercer, S&P Healthcare Economic Commercial Index, Kaiser Family Foundation, etc.), public sources of data available through the federal government (e.g., Bureau of Labor Statistics, Agency for Health Care Research and Quality, Centers for Medicare and Medicaid Services, etc.), and custom benchmarking data from large commercial health insurance carriers or managed care companies interested in incorporating their block of business benchmarks into this capability. In the preferred embodiment, a composite rate for the current cost and for each benchmark is developed as outlined under the description of the blended rate that follows.

According to an embodiment of the present invention, the application accesses specific eligibility information from the firm's census file, including, but not limited to, total members (employees and covered dependents), size of employer based upon the number of employees (stratification of employees into small, medium, large, jumbo categories), industry (single or multiple industry categories), worker characteristics (professional, management, union, full time or part time), income characteristics (top decile, top quartile, bottom quartile, etc., of income earners), elections (current tiers mapped to benchmark tiers), plan type (preferred provider organization, exclusive provider organization, health maintenance organization, consumer-driven health plan, etc.), member age (internal calculation from member dates of birth), residency (specific states and regions using state and zip code), cost areas (low, medium, and high cost areas mapped by state or zip code to specific benchmark cost area), and job risk level (normal or high risk classification mapped to excise tax category). In a preferred embodiment, the mapping methodology is a critical element in creating accurate benchmarks and is accomplished through an auto-mapping functionality that maps available variables to the required variables as well as by means of a variable-by-variable validation capability.

According to an embodiment of the present invention, the user may select from among the drop-down list of available benchmarks for calculation. There are currently six categorical selections; five are publically available sources of data (Bureau of Labor Statistics, National Compensation Survey; Department of Health and Human Services, Agency for Healthcare Research and Quality, Medical Expenditure Plan Survey Data; Office of Personnel Management, Federal Employee Health Benefits Plan Rates; Kaiser Family Foundation Health Reform Rates; and Affordable Care Act, Excise Tax Limits) and one private source of licensed data. In a preferred embodiment, all categories, a single category, multiple categories, and subcategories may be selected to allow for selection customization (e.g., region, industry, size, etc.) for best benchmark accuracy when compared to current design and cost.

According to an embodiment of the present invention, the application causes a processor to compute and report results available for graphical display in two- and three-dimensional line graphs, two- and three-dimensional bar graphs, X-axis data text labels, Y-axis numbers (calculated results), and normal logarithm and compound annual growth rate calculations. In a preferred embodiment, the number reported is a blended rate based upon the initial mapping of each employee to their respective benchmark rate based upon the enrollment tier, followed by a summation of the individual calculations by individual to determine the global cost for the total population that is then divided by the total number of employees from the census. Specific adjustment tools are made available to the user that allow for adjustments to both the benchmarks and the current per employee per year blended rate where the tweaks are subjective (user defines the percentage increase or decrease) and global (the change applies to all of the benchmarks selected) to account for the material factor differentials such as plan mix, plan changes, gender, age differentials, etc.

According to an embodiment of the present invention, all dashboard capabilities are available for Benchmarking In a preferred embodiment, results may be saved, retrieved, and populated within the global dashboard.

### Health Productivity Management

Chronic health conditions create a significant productivity economic burden beyond just the cost of providing medical benefits for employees. Productivity costs consist of the direct costs of salary continuation, short- and long-term disability and workers compensation as well as the opportunity costs resulting from lost time through unscheduled absenteeism. The estimates are that 80% of health-care expense goes toward the care of chronic conditions, that one-half of the population has one or more chronic health conditions, and that the cost per employee per year on total direct and indirect health related costs is $13,000.

According to an embodiment of the present invention, the Health Productivity Management application calculates the impact on productivity costs that result from changes in the number of conditions and/or risk levels over specific periods of time from interventions.

According to an embodiment of the present invention, the Health Productivity Management application is designed to estimate the impact to productivity costs resulting from the reduction in the number of health conditions or decrease in the number of risk levels. In a preferred embodiment, the utility does not assign causality; it only calculates results and compares them to an independently derived mean annual absent days and mean annual unproductive days measure. In another preferred embodiment, the measure may change from time to time at a user's discretion, notwithstanding, the current benchmark that is derived from an independent analysis of over 1.7 million health risk assessments participants conducted by the Optum Health Institute and published in Table 3 of “Annual Productivity Loss by Number of Health Conditions and Risk, Measuring Health Related Productivity Loss,” Population Health Management, Volume 14, Number 2, 2011.

According to an embodiment of the present invention, the four main sources for data inputs come from the human resource information, workers compensation claims payment, disability insurance carrier claims payment, and medical claims transactional processing systems. In a preferred embodiment, the basic census information has captured the basic eligibility to determine age, gender, salary, and employment status with the original census upload into HQDM. In the preferred embodiment, the human resources information system is the source for calculating the total number of full-time employees and actual salary by month along with detailed paid time off data including salary continuation payments from advise to pay programs, paid time off and extended illness banks, Family Medical Leave Act (FMLA) data, scheduled and unscheduled absenteeism data, etc., along with human resource actions (e.g., terminations, retirements, paid and unpaid leaves of absence). In the preferred embodiment, the workers compensation claims system will report the occupational related absences. In the preferred embodiment, the disability insurance carrier systems will report short- and long-term elimination periods, actual claim payments, estimated length of disability, and reserves.

According to an embodiment of the present invention, the process is to calculate employee months; that is, actual number of employees accumulated for each month for twelve months. In a preferred embodiment, the choice for the user is to select the average number of employees or the actual number of employees from the census uploaded into HQDM. Average annual salary is calculated and reported along with the number of employees.

According to an embodiment of the present invention, the user has a choice to use risk levels to perform the calculation. In a preferred embodiment, when the user chooses to use risk levels, they are electing to use the health insurance carrier's risk score calculations. These are proprietary predictive modeling risk scores imported from the carrier that are tagged to the employee and captured either in the original HQDM census upload or as a special data extract table. There is a validation process where the eligibility and risk levels or risk scores are indexed and matched. In the preferred embodiment, the user can define the number of categories for the risk levels or scores levels. The default is for three groups using the number of risk levels; as an illustration: Low (0-2 health risks), Medium (3-5 health risks), and High (5+ health risks).

According to an embodiment of the present invention, the user has a choice to use the number of health conditions to perform the calculation. In a preferred embodiment, when the user chooses to use health conditions (the default selection), the application calculates the number of conditions for each individual. In the preferred embodiment, the user can define the number of categories for the number of health conditions. The default is for three groups using the following breakdown as an illustration: No Conditions, One Condition, and Two or More Conditions.

According to an embodiment of the present invention, if the user chooses to use health conditions (the default selection), the application calculates the number of conditions for each individual. In a preferred embodiment, the user can define the number of categories for the number of health conditions. The default is for three groups using the following breakdown as an illustration: No Conditions, One Condition, and Two or More Conditions.

According to an embodiment of the present invention, the combination of the calculations and data visualizations for each category include, but are not limited to, percentage of the population (total employee count÷total employee count), total employee count, mean annual absent days, mean annual unproductive days, annual payroll, daily rate of pay, total lost days, and total PEPY cost. The total productivity cost is calculated at the beginning of the period. In a preferred embodiment, the exact same calculation process is conducted for the next period chosen (e.g., month, quarter, year). The results are reported in the form of a differential matrix that calculates the changes in each of the categories (e.g., population change, total employee count, total lost days, etc.). The comparative categorical summaries are illustrated and the aggregate period-over-period impact is exhibited as an increase or decrease in the total productivity cost and the dollar amount of savings.

According to an embodiment of the present invention, all dashboard capabilities are available for Health Productivity Management. In a preferred embodiment, results may be saved, retrieved, and populated within the global dashboard.

### Advanced Financial Analytics

According to an embodiment of the present invention, Advanced Financial Analytics is an application that provides time-series forecasting and Monte Carlo simulation for use in decision support.

According to an embodiment of the present invention, Advanced Financial Analytics is an application designed as a financial decision support utility. The time-series forecasting application provides state-of-the-art, advanced forecasting techniques for use in development of projections with greater precision and statistical credibility than the traditional midpoint-to-midpoint trending approaches. The Monte Carlo simulation application provides a utility that sets assumptions on the inputs used in decision-making models and generates a statistical distribution of randomly generated outcomes. This distribution constitutes the range of possible outcomes that are more useful in decision making than the use of single-point estimates. In a preferred embodiment, the application is used for simplifying the forecasting and simulation utilities in HQDM for ease of use. In the preferred embodiment, the application uses a menu-driven, step-by-step set of instructions to assist users in the selection and construction of the correct forecasting models and how to establish Monte Carlo simulations.

According to an embodiment of the present invention, the advanced forecasting utility is separated into three groups—Trend Line, Time Series, and Econometrics. In a preferred embodiment, the elements of the Trend Line include, but are not limited to, exponential, linear, polynomial, logarithmic, moving average, and power. In the preferred embodiment, the elements of the Time Series include, but are not limited to, linear, double exponential smoothing, double moving average, Holt Winters additive, Holt Winters multiplicative, seasonal additive, seasonal multiplicative, single exponential smoothing, and single moving average. In the preferred embodiment, the elements of Econometrics include basic econometrics and autoregressive integrated moving average (ARIMA).

According to an embodiment of the present invention, there will be access to some of the Excel-based templates with the HQDM Com Add-in as the basis for some basic econometric modeling and method consolidation of the results.

According to an embodiment of the present invention, the output for the advanced forecasting utility will be in the form of a data table reporting both original data and calculated results. In a preferred embodiment, the original data elements may include month-by-month counts of employees, members, medical claims, and prescription drug claims, and calculations including a PMPM (default) or PEPM dollar amount for each month. In the preferred embodiment, the forecasted data will be exhibited as a month-by-month calculation of projected PMPM (default) or PEPM claims. The monthly PMPM results for the twelve-month projection period are summed and compared to the original results to determine the projected trend increase or decrease from the original as a percentage.

According to an embodiment of the present invention, the user will be guided by some specific guidelines in the selection of the appropriate forecasting model from which to select as described in the time-series analysis summary. For example, the following double moving-average description is representative of the type of description accompanying the results: The double moving average method smooths out past data by performing a moving average on a subset of data that represents a moving average of an original set of data. That is, a second moving average is performed on the first moving average. The second moving-average application captures the trending effect of the data. The results are then weighted and forecasts are created. The software finds the optimal moving-average lag automatically through an optimization process that minimizes the forecast errors.

According to an embodiment of the present invention, the simulation utility is designed to develop a step-by-step approach in creating, changing, and editing a profile, setting input assumptions and output forecasts, running simulations, extracting key metrics from the statistics, and setting distribution displays (e.g., two tail, left-tail, etc.) and confidence intervals (e.g., 95%, 90%, 80%, etc.).

According to an embodiment of the present invention, the output for the Monte Carlo simulation consists of an easy to view histogram that represents the distribution of outcomes accompanied by detailed statistical descriptions of the distribution (e.g., number of trials, mean, median, standard deviation, maximum, minimum, range, skewness, 25th percentile, 75th percentile, etc.). In a preferred embodiment, the user has the option of selecting the tail type of the distribution (e.g., two tail, left tail, right tail, etc.) and the certainty % (e.g., 95%, 90%. 85%, etc.).

According to an embodiment of the present invention, all dashboard capabilities are available for Advanced Financial Analytics. In a preferred embodiment, results may be saved, retrieved, and populated within the global dashboard.

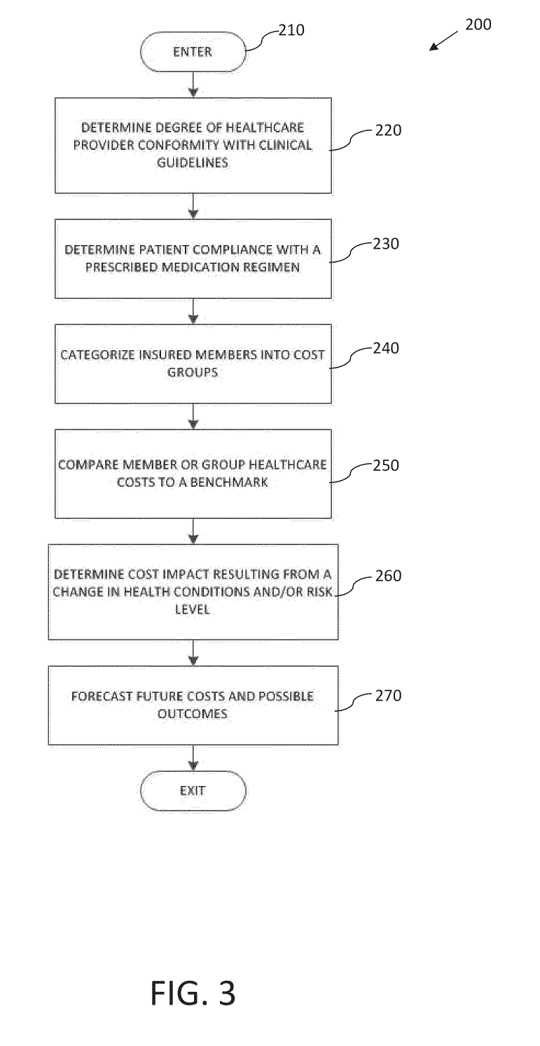

Referring to FIG. 3, a process for analyzing and reporting operational performance of healthcare management is illustrated. The process begins at the enter operation 210 and process flow proceeds to determining the degree of healthcare provider conformity with clinical guidelines 220. Clinical guidelines are also referred to as standard practice guidelines and the degree of conformity to such guidelines may be represented by a clinical compliance percentage as previously discussed. The process next proceeds to determining patient compliance with a prescribed medication regimen 230. This can be accomplished by calculating the medicine possession ratio within the applicable disease category. Process flow next proceeds to categorize insured members into different cost groups 240. Cost groups may be defined according to the cost associated with healthcare claims submitted by a member or group over a certain period of time. Upper and lower boundaries for each costs group may be set according to a user's preference and the user may create one or more of such cost groups as discussed earlier.

The next operation in the process compares member or group healthcare costs to a benchmark 250. The benchmark may be statistically derived, such as mean cost incurred over a certain period of time. In addition, the benchmark may be based on a person or group that has a similar demographic profile to the member or group being evaluated. The process flow next proceeds to determine cost impact resulting from a change in health conditions and/or risk level 260. As previously discussed, an intervention that leads to a reduction in detrimental health conditions should reduce costs. Similarly, lifestyle choices may increase or decrease risk level which will likely lead to a change in costs over a period of time.

Process flow next proceeds to the forecast operation 270 in which future costs and possible outcomes are projected. The forecast operation may utilize a monte carlo simulation, which uses randomly generated variables for the decision making operations discussed above to produce various outcomes that can be statistically evaluated and modeled. Once all or part of the financial forecast is provided, process flow proceeds to the exit operation. Furthermore, one of ordinary skill in the art will appreciate that the above-described operations of process 200 may be performed in any order, and one or more operations may be skipped at the discretion of the user.

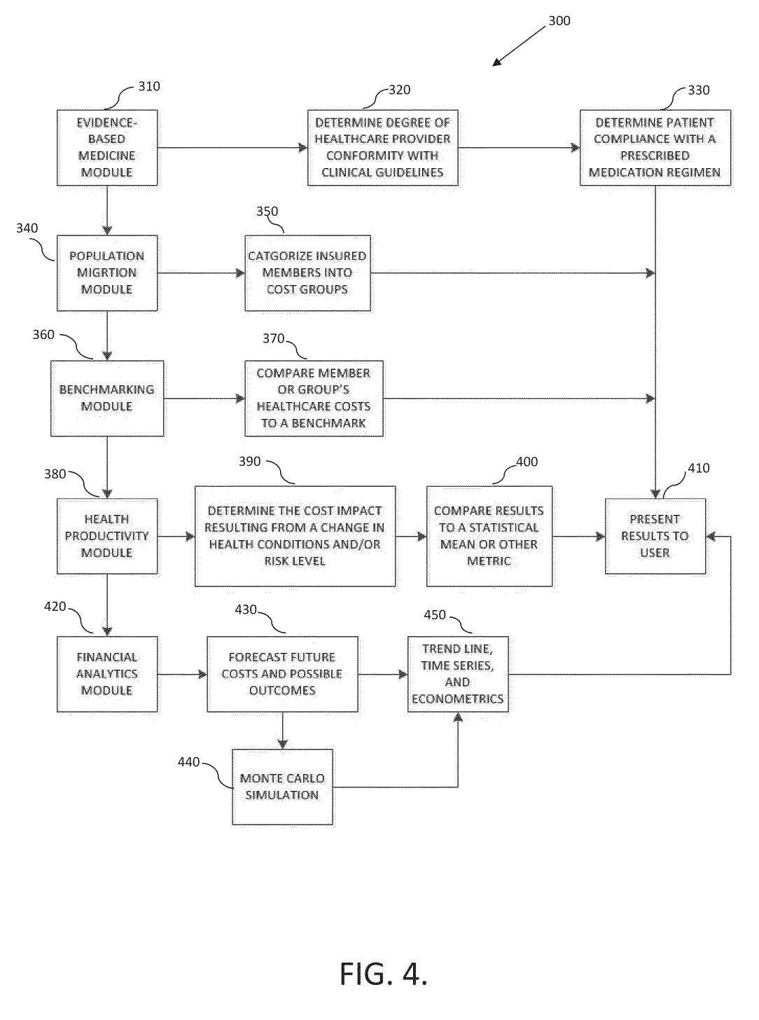

FIG. 4 shows a schematic view of the system 300 according to an embodiment of the present invention. The Evidence-Based Medicine Module 310 is configured to determine the degree of healthcare provider compliance with standard practice guidelines 320 and patient compliance with a prescribed medication regiment 330. In one embodiment, the Evidence-Based Medicine Module 310 is a third-party software application incorporated into the system 300 under a license agreement.

Population Migration Module 340 divides insured members into cost groups 350 depending on the cost of filed claims for respective members over a certain period of time. As discussed previously, these cost groups may be defined based on user preference. The number of groups may also be adjusted according to need or preference.

The Benchmark Module 360 is configured to compare a member or group's healthcare costs to a statistical benchmark 370. There are numerous potential sources for these benchmarks including independent census data, survey data, or sampling data. In addition, internally developed benchmarks may be used, such as the average healthcare costs for insured members over a specified period of time. Random or predetermined values may also be used as benchmarks in simulations, such as a monte carlo simulation. Similarly, member or group costs may also be simulated with random or predetermined values. These types of simulations help to identify and analyze different potential outcomes.

The Health Productivity Module 380 is configured to determine the cost impact of a change in health conditions 390, such as a reduction in the number of health conditions for a member or group. Similarly, a member or group's risk level over a particular time period may be evaluated to determine financial impact 390. Risk level may be based on risk due to health condition, lifestyle, past risky behavior, or periodic exposure to risk due to work, hobbies, or non-work related activity. Healthcare costs associated with members or groups may be compared to a statistical mean or other metric 400.

The Financial Analytics Module 420 is configured to forecast future costs and possible outcomes 430 based on data and results calculated in the other modules. For example, identified deviation from clinical guidelines reported in the Evidence Based Medicine Module could to lead to higher costs and possible legal action. Similarly, migration of members from lower cost groups to higher cost groups is likely to lead to higher overall costs. Trends in costs relative to one or more benchmarks, and changes in health conditions/risk level are also likely to impact overall costs. The Financial Analytics Module may also run based on simulated data, such as a monte carlo simulation. Simulated data may include randomly generated inputs or predetermined inputs, in order to generate a statistical distribution of outcomes for analysis. Results can then be analyzed in the context of trend lines, time series graphs or tables, and econometrics 450. A person of ordinary skill will recognize that such methods of analyzing and presenting data are well known. Results for one or more modules 410 may be presented in a variety of forms including: graphs, tables, text, animation, audio/visual presentation, symbols, or any other form that conveys the result in a convenient, easy to understand manner.

As described above, the present invention encompasses a computer-implemented method and system for analyzing and evaluating the performance of health plan management. With this invention a user can use the analytical tools defined herein to optimize administration of a health plan.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A computer program product for providing a process of analyzing and reporting operational performance for health plan management comprising:
a non-transitory computer readable medium; and
computer program code, encoded on the computer readable medium, comprising:
an evidence-based medicine module, wherein said evidence-based medicine module is configured to determine the degree of healthcare provider conformity with clinical guidelines, determine patient compliance with a prescribed medication regimen,
a population migration module, wherein said population migration module categorizes insured members into cost groups;
a benchmarking module, wherein said benchmarking module compares an insured member or group's healthcare costs to a benchmark for a person or group having a similar demographic profile;
a health productivity module, wherein said health productivity module determines the cost impact that results from a change in a member's health conditions and/or risk level; and
a financial analytics module, wherein said financial analytics module provides forecasts of future costs and possible outcomes based, at least in part, on the results provided by one or more of the above modules.

2. The computer program product of claim 1, wherein said evidence based medicine module is a third-party evidence-based medicine software application.

3. The computer program product of claim 1, wherein said clinical guidelines comprise detailed physician measurement metrics for treating a specific disease.

4. The computer program product of claim 1, wherein said clinical guidelines comprise one or more identified measures of care.

5. The computer program product of claim 4, wherein said identified measures of care are from the chronic disease management guidelines published in “Technical Specifications for Physician Measurement.”

6. The computer program product of claim 1, wherein said identified measures of care comprise subsets of the “Healthcare Effectiveness Data and Information Set” (HEDIS) measures developed by the National Committee for Quality Assurance (NCQA).

7. The computer program product of claim 1, wherein said degree of healthcare provider conformity comprises a clinical compliance percentage.

8. The computer program product of claim 1, wherein said patient compliance with a prescribed medication regimen is determined by a medicine possession ratio.

9. The computer program product of claim 1, wherein said cost groups are based on costs associated with an insured member's healthcare claims over a certain period of time.

10. The computer program product of claim 1, wherein said cost impact is based, at least in part, on number of days absent from work

11. The computer program product of claim 1, wherein said cost impact is based, at least in part, on number of unproductive work days over a specified period of time.

12. The computer program product of claim 10, wherein said cost impact is compared to a statistical mean.

13. A system for analyzing and reporting operational performance for healthcare management comprising:
a processor;
a memory coupled to the processor, the memory having processor executable instructions stored therein, wherein execution of said processor executable instructions performs a process for analyzing and reporting operational performance comprising:
determining the degree of healthcare provider conformity with clinical guidelines;
determining patient compliance with a prescribed medication regimen;
categorizing insured members into cost groups;
comparing an insured member or group's healthcare costs to a benchmark for a person or group having a similar demographic profile;
determining the cost impact resulting from a change in a member's health conditions and/or risk level; and
forecasting future costs and possible outcomes based, at least in part, on the results provided by one or more of the above steps.

14. The system of claim 12, wherein said clinical guidelines comprise detailed physician measurement metrics for treating a specific disease.

15. The system of claim 12, wherein said clinical guidelines comprise one or more identified measures of care.

16. The system of claim 12, wherein said one or more identified measures of care are from the chronic disease management guidelines published in “Technical Specifications for Physician Measurement.”

17. The system of claim 12, wherein said identified measures of care comprise subsets of the “Healthcare Effectiveness Data and Information Set” (HEDIS) measures developed by the National Committee for Quality Assurance (NCQA).

18. The system of claim 12, wherein said degree of healthcare provider conformity comprises a clinical compliance percentage.

19. The system of claim 12, wherein said patient compliance with a prescribed medication regimen is determined by a medicine possession ratio.

20. The system of claim 12, wherein said cost groups are based on costs associated with an insured member's healthcare claims over a certain period of time.

21. The system of claim 12, wherein said cost impact is based, at least in part, on number of days absent from work or number of unproductive work days over a certain period of time.

22. The system of claim 12, wherein said risk level may be divided into one or more risk categories.

23. The system of claim 12, wherein said health conditions are divided into one or more categories based on number of health conditions.

24. The system of claim 12, wherein said health conditions are divided into one or more categories based on type of health conditions.

25. The system of claim 12, wherein said cost impact is compared to a statistical mean.

26. A method for analyzing and reporting operational performance for healthcare management, said method comprising the steps of:
determining the degree of healthcare provider conformity with clinical guidelines;
determining patient compliance with a prescribed medication regimen;
categorizing insured members into cost groups;
comparing an insured member or group's healthcare costs to a benchmark for a person or group having a similar demographic profile;
determining the cost impact resulting from a change in a member's health conditions and/or risk level; and
forecasting future costs and possible outcomes based, at least in part, on the results provided by one or more of the above steps.
